(19) United States
(12) Patent Application Publication
(10) Pub. No.: US 2020/0080369 A1
(43) Pub. Date: Mar. 12, 2020

(54) DUAL PURPOSE FOLDABLE SOLAR ELECTRICITY SUPPLY APPARATUS FOR OUTDOOR AND WINDOW BLIND

(71) Applicant: Nir ACHIEL, Raanana (IL)

(72) Inventor: Nir ACHIEL, Raanana (IL)

(21) Appl. No.: 16/611,220

(22) PCT Filed: May 24, 2018
(86) PCT No.: PCT/IL2018/050575

§ 371 Date: Nov. 6, 2019

Related U.S. Application Data
(60) Provisional application No. 62/510,767, filed on May 25, 2017.

(51) Int. Cl. E06B 9/386; H02S 20/26; H02S 30/20; H02S 40/38; H02S 40/32; H02J 7/35; E06B 9/32; E06B 9/323; E06B 9/36

(52) U.S. Cl. CPC E06B 9/386; H02S 20/26; H02S 30/20; H02S 40/38; E06B 2009/2476; H02J 7/355; E06B 9/32; E06B 9/323; E06B 9/36; H02S 40/32

(57) ABSTRACT

A window blind apparatus for providing solar energy comprises: (a) a case configured for receiving a battery, the case including electrical battery charging circuitry; and, (b) a plurality of photovoltaic panels configured for receiving solar radiation and converting the radiation into electricity, each of the photovoltaic panels in electrical communication with the electrical battery charging circuitry, and, each photovoltaic panel is in communication with at least one other panel, such that the panels are moveable.

### FIELD OF THE INVENTION

The field of the invention relates in general to solar energy collecting apparatus.

### BACKGROUND OF THE INVENTION

Photovoltaic cells for storing solar energy have been widely adopted for both domestic and industrial purposes. For example, solar panels of photovoltaic cells are commonly used on roofs and external surfaces of buildings and houses.

### SUMMARY OF THE INVENTION

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

The present invention provides a dual purpose solar apparatus which can alternatively be used outdoor for supplying electricity, or as a window blind with electricity supply capability. The apparatus of the present invention can be made foldable, light weight, and compact.

The invention relates to a dual-purpose apparatus for solar electricity supply indoor and outdoor, and for window blind indoor, which includes: (a) a case which contains a battery, and a mechanism for operating the apparatus as a window blind; (b) a plurality of dual purpose photovoltaic and shading panels; (c) attachment elements for attaching the apparatus to a lintel or a side frame of a window, while the apparatus operates as windows blind; and (d) removable legs for supporting the apparatus while operating outdoor as an electricity supply apparatus.

The apparatus further includes electric wires for conveying electricity from the photovoltaic and shading panels to the battery within the case.

Optionally, each photovoltaic and shading panel includes a plurality of photovoltaic units, each photovoltaic unit includes a plurality of photovoltaic cells.

Optionally, the apparatus further includes a built-in lamp.

Optionally, the built-in lamp is of a LED-type.

Optionally, the removable legs are telescopic legs.

Optionally, the removable legs are foldable.

Optionally, the apparatus further includes a USB DC output socket.

Optionally, the apparatus further includes a DC to AC converter, and an AC output socket.

Optionally, the apparatus further includes mechanism for tilting the photovoltaic and shading panels.

Optionally, the apparatus further includes a control circuit for disconnecting the battery from the photovoltaic and shading panels when the battery is fully charged.

Optionally, the attachment elements are loop wires that are attached to the top of the case, enabling hanging of the apparatus from the lintel of the window.

Optionally, the photovoltaic and shading panels are horizontal during operation.

Optionally, the photovoltaic and shading panels are vertical during operation.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a perspective view of the apparatus of the invention, in its outdoor use, in accordance with the present invention;

FIGS. 2A and 2B illustrate front and perspective views of the apparatus of the invention in its folded (packed) state;

FIGS. 3A and 3B show in perspective views various states of the built-in lamp of the apparatus;

FIG. 4 shows a perspective view of the apparatus of the invention in its window-blind form;

FIG. 5 illustrates in a diagrammatic view the structure of the solar panels of the apparatus;

FIG. 6 shows an exploded view of the apparatus of FIG. 1; and

FIG. 7 illustrates in a perspective view the elements for attaching the apparatus to side beams of the window frame.

### DETAILED DESCRIPTION OF THE DRAWINGS

The present invention provides a foldable solar apparatus which may be used either outdoor for supplying electrical energy, or indoor as a window blind having electrical energy supply capabilities. The apparatus is, for example, used as a window blind.

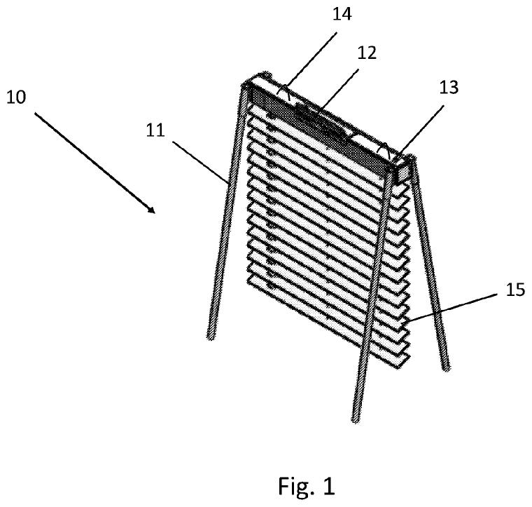

FIG. 1 illustrates an apparatus 10, for example, in an outdoor installation. The apparatus 10 is foldable and is formed of a plurality of solar-shading panels 15, four foldable, telescopic and/or removable legs 11 (for an outdoor use), a case 13, attachment elements 14 to a lintel of a window (for an indoor use), and a lamp 12 (optionally of a LED type).

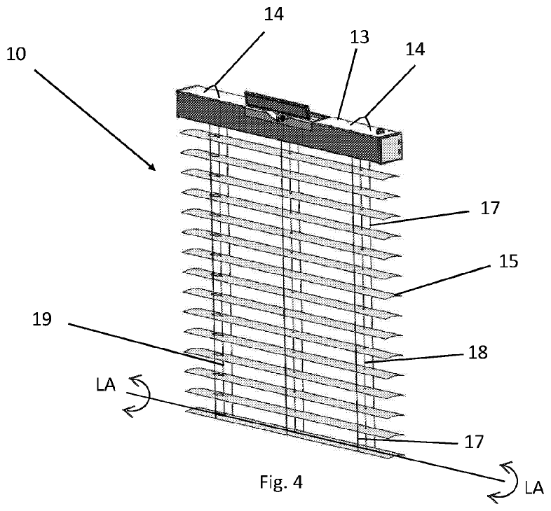

The panels 15 are dual purpose elements. When the apparatus is applied indoor as a window shading, the solar panels 15 are used for (a) accumulation of electrical energy; and (b) shading from the sun. When the apparatus 10 is used outdoor, the solar panels 15 are typically used for the accumulation of electrical energy. In addition, for example when the apparatus 10 is on the beach, the user may enjoy the shading caused by the solar panels, while laying behind the apparatus. Furthermore, the panels 15 may be curved in their cross section (as best shown in FIG. 4), or flat, as is conventional for photovoltaic panels.

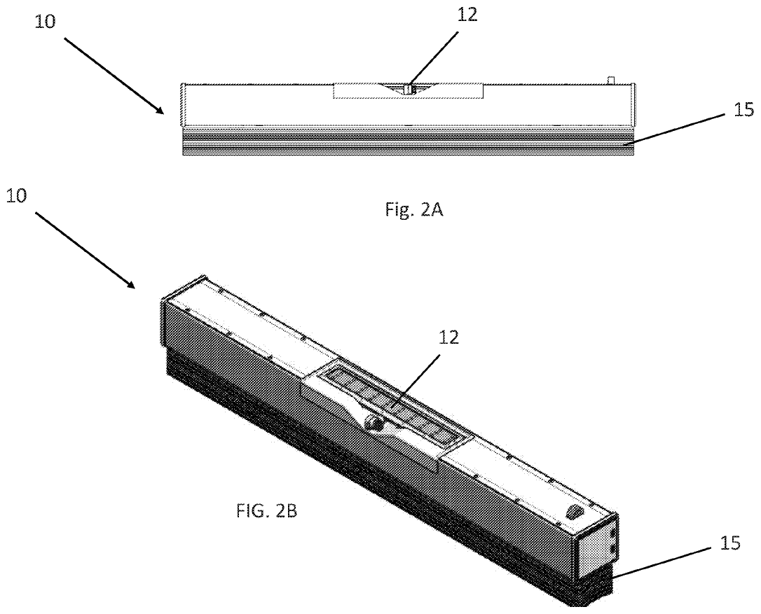

The apparatus 10 is foldable, as each of the foldable, telescopic, and/or removable legs is attached to case 13 by a suitable connector (not shown in the figure). The apparatus is foldable for another reason, as its volume is significantly reduced in its packed form (where the panels are tightly stacked), as shown in FIGS. 2A and 2B. The legs connector has an essentially tubular shape (circular or otherwise) section for accepting an end of the leg (the end which is opposite to the end which is in contact with the ground).

In one option, the connectors are removable together with their respective legs. In another option, only the legs 15 are removable, while the connectors remain attached to the case 13. In still another option, neither the legs nor the connectors are removable. In the latter case, when the apparatus is in its folded state, or when used indoor as a window blind, each telescopic leg is telescopically contracted, and rotated substantially 90° to be in parallel to the case 13.

In order to enable an indoor use, the apparatus 10 of the invention also includes attachment mechanisms, for attaching the apparatus to the lintel of the window. For example, the attachment may be in the form of two (or more) cord (or solid) loops 14, each to be connected in a hanging form to a corresponding hook at the lintel of the window. Other alternatives for attaching the apparatus 10 to the lintel of the window will be described hereinafter.

The (optional) lamp 12 is preferably a LED-type lamp. Preferably, the lamp is retractable or foldable to within the case 13 when not in use. The lamp may include an ON/OFF switch for turning the lamp ON or OFF.

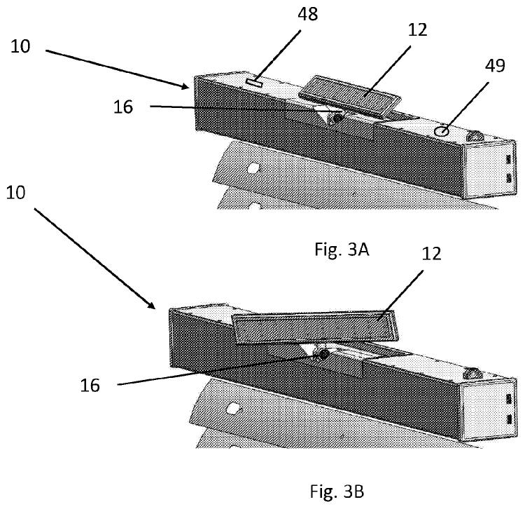

The apparatus 10 also includes one or more sockets 48 and 49 (shown in FIG. 3A) for outputting electricity to one or more external devices. In one embodiment, the apparatus includes a USB socket 48, to enable charge of portable devices, such as cellular phones, laptops, etc. In another embodiment, the apparatus may also include a DC to AC converter (commonly referred to in the art as “inverter”) for converting the DC output from the battery of the apparatus to AC, and a respective AC socket 49, thereby to enable feeding of conventional AC devices.

FIGS. 2A and 2B illustrate front and perspective views of the apparatus 10 in its folded (packed) state. As shown, the lamp 12 is folded to within the case 13, and the solar panels are tightly contracted as shown.

As shown in FIGS. 3A and 3B, the lamp 12 is preferably connected to within the case 13 by a lamp attachment element 16. The lamp attachment element 16 is axially attached at one of its ends to a corresponding element within case 13, and axially attached at its opposite end to the lamp, therefore to enable tilting of the lamp 12 and rotation thereof in two degrees of freedom.

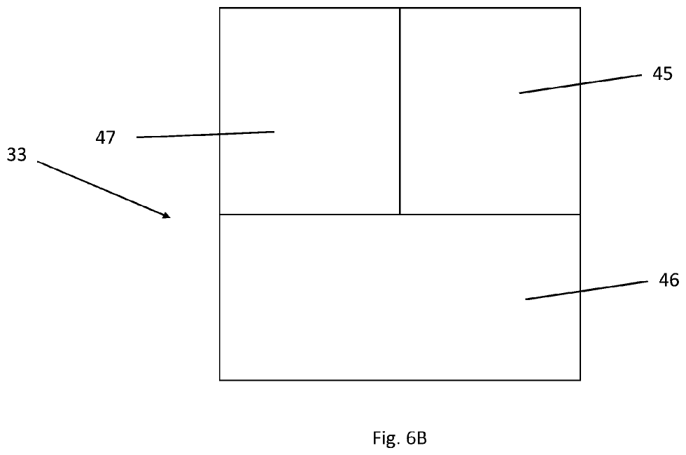

FIG. 4 shows the apparatus 10 in its window-blind form. The cords 17 are used to tilt the dual function panels towards the sun thereby to adjust the level of shading as is done in a conventional window-blind apparatus, or the tilt may be used to better direct the photovoltaic panels to the sun, thereby to increase the level of electrical energy creation by the panels 15. Wire 18 conveys the (+) output polarity of the solar panels 15 (all connected in parallel) to the within case 13, while wire 19 conveys the (−) polarity of panels 15 to within the case 13. In such a manner, charging current can flow from the solar panels 15 to the battery 36 within the case 13 (shown in FIG. 6), thereby to accumulate electrical energy caused by exposure of dual purpose photovoltaics and shading panels 15 to the sun.

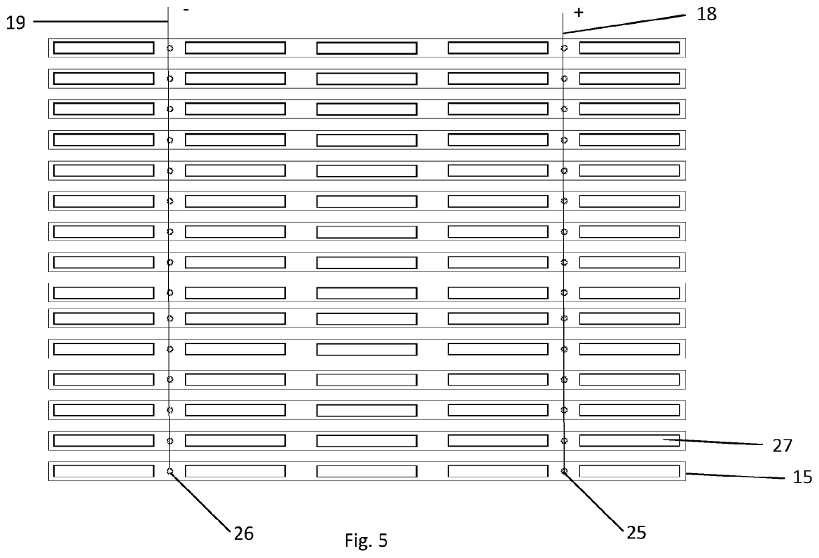

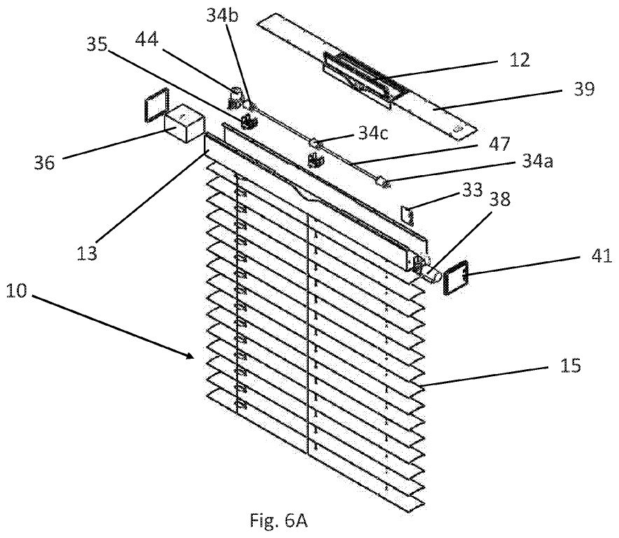

FIG. 5 illustrates in a schematic form the structure of the solar panels of the apparatus 10. The apparatus may include, for example, 15 solar panels 15. Each solar panel 15 may include one or more photovoltaic units 27, each unit 27 includes a plurality of photovoltaic cells. There is no limitation to the number of panels, units, or cells in the apparatus of the invention. In the exemplary structure of FIG. 5, the units within each panel are connected in series, for example, in a printed circuit manner. All the 15 solar panels are connected in parallel by the positive wire 18 and negative wire 19, respectively. The positive and negative wires 18 and 19, pass between the panels via the holes 25 and 26, respectively. The (+) and (−) wires 18 and 19, respectively, are connected to the battery 36 (directly or via a control circuit), which is located within the case 13 (see FIG. 6).

FIG. 6 shows in an exploded view the structure of the apparatus 10 of the invention, particularly the internal structure of the case 13. The mechanical structure within the casing 13 is substantially similar to the structure of a conventional window blind apparatus, with some differences with respect to the electrical section, which does not exist in a conventional window blind. Longitudinal hinge 47 includes, for example, left, center, and right tilting rollers 34a, 34b, and 34c, over which the left, center, and right tilting cords 17 of the panels are wound respectively. The tilting cords 17 are used to rotate the panels nearly 180°, such that they slightly overlap with one side facing inward, and then in the opposite direction such that they slightly overlap with the other side facing inward. Between those extremes, various degrees of separation may be formed between the panels 15 by varying the rotation. The panels lifting cord (not shown) is rolled over the panel lifting rollers 38 and 44 in a conventional manner. This lifting cord allows the blind to be pulled up and stack tightly (as in FIGS. 2A and 2B) to the case 13, when desired. In fact, when these cords are pulled, the bottom of the blind moves upward, causing the lowest panel 15 to press the underside of the next highest panel as the blind is raised. The control circuit 33 controls the electronic operation of the apparatus. More specifically, it controls the charging flow from the plurality of solar panels to the battery 36. For example, when the battery is fully charged, the circuit disconnects the battery 36 from the photovoltaic panels 15, in order to avoid damage to the battery. The positive and negative wires 18 and 19, respectively (see FIG. 4) are connected to the control circuit 33, and another pair of wires (not shown) connect between the control circuit 33 and the battery 36. In one embodiment, control circuit 33 also feeds the lamp 12, as well as one or more electricity sockets that are provided by the apparatus. For example, the control circuit 33 may convert the DC voltage of the battery to a DC level suitable for the operation of the lamp 12. Moreover, the control circuit 33 may convert the battery voltage to a voltage level suitable for an output USB socket (48 in FIG. 3A). The control circuit may also include a DC to AC converter (commonly also referred to as “inverter”), for converting the DC to an AC which is suitable for operation of conventional AC appliances. Socket 49 (shown in FIG. 3A) serves the AC output (if exists) from the apparatus 10. Top cover 39, and side walls 41 close the case 13.

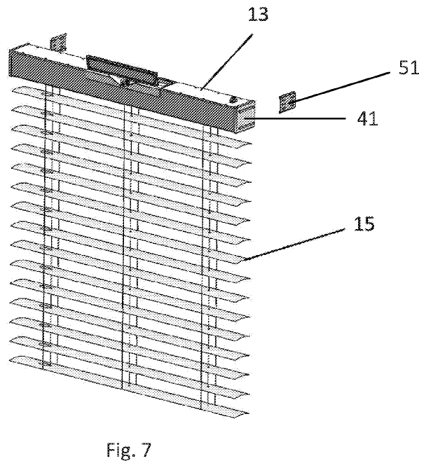

As shown in FIG. 1, the apparatus includes two loop wires (or similar solid structure) 14, used for hanging the apparatus on corresponding hooks attached to the lintel of the window. The apparatus of the invention may alternatively be attached to the side beams of the window frame. As shown in FIG. 7, the apparatus may include two side connectors 51 that are attached to the two side beams of the window. The side connectors 51 are compatible with the two side covers 41 of case 13. For example, the connectors 51 may include slots that are compatible with the protrusions in side covers 41, so in such a manner the apparatus will be maintained stable in a horizontal orientation within the window frame. In order to adapt the length of the case 13 to a variety of windows dimensions, the case 13 may optionally be made telescopic. In still another option, when the concrete frame of the windows allows, the apparatus may be positioned on top of the lower section of the concrete frame of the window, while being supported by legs 11, exactly as is used outdoors.

As shown, the application provides a dual-purpose apparatus which can be used alternatively for outdoor electricity supply or as an indoor window blind with electricity supply capability. The structure of the apparatus described above has been provided for illustration only, as the apparatus may have various structures that are within the scope of the invention. For example, while the exemplary apparatus described above includes horizontal panels, window blinds having vertical panels are well known. In a similar manner, the apparatus of the invention may include vertical solar panels, rather than the horizontal ones. In fact, the dual-purpose outdoor and indoor apparatus of the invention may take the general structure of any known window blind, as long as the conventional panels are replaced by solar panels, and the apparatus includes elements for supporting the apparatus outdoor.

While the invention has been described with respect to a limited number of embodiments, it will be appreciated that many variations, modifications and other applications of the invention may be made. Therefore, the claimed invention as recited in the claims that follow is not limited to the embodiments described herein.

1. A dual-purpose apparatus for solar electricity supply indoor and outdoor, and for window blind indoor, which comprises:
a case which contains a battery, and a mechanism for operating the apparatus as a window blind;
a plurality of dual purpose photovoltaic and shading panels;
attachment elements for attaching the apparatus to a lintel or a side frame of a window, while the apparatus operates as windows blind; and
removable legs for supporting the apparatus while operating outdoor as an electricity supply apparatus.

2. Apparatus according to claim 1, further comprising electric wires for conveying electricity from the photovoltaic and shading panels to the battery within the case.

3. Apparatus according to claim 1, wherein each photovoltaic and shading panel comprises a plurality of photovoltaic units, each photovoltaic unit comprises a plurality of photovoltaic cells.

4. Apparatus according to claim 1, further comprising a built-in lamp.

5. Apparatus according to claim 4, wherein the built-in lamp is of a LED-type.

6. Apparatus according to claim 1, wherein said removable legs are telescopic legs.

7. Apparatus according to claim 1, wherein said removable legs are foldable.

8. Apparatus according to claim 1, which comprises a USB DC output socket.

9. Apparatus according to claim 1, which comprises a DC to AC converter, and an AC output socket.

10. Apparatus according to claim 1, further comprising mechanism for tilting the photovoltaic and shading panels.

11. Apparatus according to claim 1, further comprising a control circuit for disconnecting the battery from the photovoltaic and shading panels when the battery is fully charged.

12. Apparatus according to claim 1, wherein said attachment elements are loop wires that are attached to the top of the case, enabling hanging of the apparatus from the lintel of the window.

13. Apparatus according to claim 1, wherein the photovoltaic and shading panels are horizontal during operation.

14. Apparatus according to claim 1, wherein the photovoltaic and shading panels are vertical during operation.
